(19) United States
(12) Patent Application Publication
(10) Pub. No.: US 2014/0308119 A1
(43) Pub. Date: Oct. 16, 2014

(54) HYDRAULIC MACHINERY

(71) Applicant: Kabushiki Kaisha Toshiba, Minato-Ku (JP)

(72) Inventors: Sho HARADA, Yokohama-Shi (JP); Sadao Kurosawa, Yokohama-Shi (JP); Hideyuki Kawajiri, Yokohama-Shi (JP); Atsuhito Nishimoto, Kawasaki-Shi (JP)

(73) Assignee: Kabushiki Kaisha Toshiba, Minato-Ku (JP)

(21) Appl. No.: 14/316,106

(22) Filed: Jun. 26, 2014

Related U.S. Application Data
(63) Continuation of application No. PCT/JP2013/077152, filed on Oct. 4, 2013.

(30) Foreign Application Priority Data
Oct. 17, 2012 (JP) 2012-229947

(51) Int. Cl. F03B 3/18; F03B 3/02

(52) U.S. Cl. CPC F03B 3/18; F03B 3/02
USPC 415/208.2

(57) ABSTRACT

A hydraulic machinery 1 comprises: vanes 10 that are circumferentially arranged side by side; and rotatable guide vanes 20 that are arranged inside the respective stay vanes.

An outlet end-point 11 of each stay vane is in contact with a common reference circle. Each guide vane includes a pressure side blade surface 21 and a negative-pressure side blade surface 22, and has a camber line connecting centers of inscribed circles 24 that are in contact with both the blade surfaces 21, 22. When each guide vane takes a maximum opening degree, a central point O of a maximum inscribed circle 24m is located on an outlet side of the guide vane, relative to an intersection point 32 at which a line as the shortest distance, which is drawn between the outlet end-point and the negative-pressure side blade surface 22, and the camber line 25 intersect with each other.

### TECHNICAL FIELD

An embodiment of the present invention relates to a hydraulic machinery.

### BACKGROUND ART

As a hydraulic machinery for generating power by using hydraulic power, a Francis turbine is known, for example. FIG. 10 shows one structural example of a Francis turbine. As shown in FIG. 10, the Francis turbine includes a casing 502, a plurality of stay vanes 510 that are circumferentially arranged side by side in the casing 502, and a plurality of guide vanes 520 each of which is arranged inside corresponding stay vane 510 and is configured to be rotated about a rotation shaft 523. A stationary blade row flow path 531 (see FIG. 11) is formed between the stay vanes 510 and the guide vanes 520. A runner 503 is rotated by water flowing through the stationary blade row flow path 531. A turbine main shaft 504 is connected to the runner 503. A generator (not shown) is driven through the turbine main shaft 504.

When the Francis turbine is operated as a generator, water flowing from the casing 502 flows through the stationary blade row flow path 531 formed between the stay vanes 510 and the guide vanes 520 on the inner circumferential side, and the water flows into the rotatable runner 503 so as to rotate the runner 503. Due to the rotation of the runner 503, the generator (not shown) is driven in rotation through the turbine main shaft 504. The water flowing out from the runner 503 is guided to a discharge channel (not shown) via a draft tube 505.

On the other hand, in a case where the Francis turbine is constructed as a pump turbine, when the Francis turbine is operated as a pump, water flowing from the draft tube 505 passes through the runner 503 to flow through the stationary blade row flow path 531 between the stay vanes 510 and the guide vanes 520. Then, the water flows outside from the casing 502.

Next, the stay vanes 510 and the guide vanes 520 are described in more detail with reference to FIG. 11. FIG. 11 is a schematic sectional view showing the stay vanes 510 and the guide vanes 520, in a section perpendicular to the rotation shaft 523 of the guide vane 520 of FIG. 10. As shown in FIG. 11, the plurality of stay vanes 510 and the plurality of guide vanes 520 are circumferentially arranged side by side, respectively. Each of the guide vanes 520 is rotated about the rotation shaft 523 to regulate a guide vane opening degree, so that a flowrate of water flowing between the guide vane 520 and the other guide vane 520 adjacent thereto is varied. Thus, a flowrate of water flowing into the runner 503, which is disposed on an outlet side of the guide vanes 520, is regulated, whereby an output of the generator is regulated. An outer contour of the guide vane 520 is defined by a pressure side blade surface 521 and a negative-pressure side blade surface 522. A central point O1 of a maximum inscribed circle 524m, which is the largest one among inscribed circles that are in contact with both the pressure side blade surface 521 and the negative-pressure side blade surface 522, is located on an inlet side of the guide vane 520.

### PRIOR ART DOCUMENTS

### Patent Documents

[Patent Document 1] JP10-184523A

[Patent Document 2] JP3-267583A

[Patent Document 3] JP2003-90279A

[Patent Document 4] JP2007-113554A

### DISCLOSURE OF THE INVENTION

In order to increase an output of the generator, it is necessary to enlarge the guide vane opening degree so as to increase a flowrate of water flowing into the runner 503. However, in the aforementioned hydraulic machinery, since the central point O1 of the maximum inscribed circle 524m is located on the inlet side of the guide vane 520, when the guide vane opening degree is enlarged, the stationary blade row flow path 531 formed between the stay vanes 510 and the guide vanes 520 becomes extremely narrow in the vicinity of the maximum inscribed circle 524m. Thus, a flowrate of the water flowing through the stationary blade row flow path 531 may locally increase in the vicinity of the maximum inscribed circle 524m, which invites problems such as a large frictional loss between the flowing water and the stay vanes 510 and between the flowing water and the guide vanes 520, or a water power loss caused by a flow separation or eddy in the stationary blade row flow path 531.

The object of the present invention is to decrease a water power loss in a flow path formed between stay vanes and guide vanes, by locating a maximum inscribed circle of the guide vane on an optimum position.

According to one embodiment, there is provided a hydraulic machinery including: a plurality of stay vanes that are circumferentially arranged side by side, each including an outlet end point; and
a plurality of guide vanes that are arranged inside the corresponding stay vanes, each including a pressure side blade surface and a negative-pressure side blade surface, and being configured to be rotated about a rotation shaft;
wherein:
the outlet end point of each stay vane is in contact with a common reference circle;
each guide vane has a camber line connecting centers of inscribed circles that are in contact with both the pressure side blade surface and the negative-pressure side blade surface; and
when each guide vane takes a maximum opening degree, a central point of a maximum inscribed circle, which has the largest diameter among the inscribed circles of the guide vane, is located on an outlet side of the guide vane, relative to an intersection point at which a line as the shortest distance, which is drawn between the outlet end point of the stay vane and the negative-pressure side blade surface of the corresponding guide vane, and the camber line intersect with each other.

Alternatively, according to another embodiment, there is provided a hydraulic machinery including: a plurality of stay vanes that are circumferentially arranged side by side; and
a plurality of guide vanes that are arranged inside the corresponding stay vanes, each including a pressure side blade surface and a negative-pressure side blade surface, and being configured to be rotated about a rotation shaft;
wherein:
each guide vane has a camber line connecting centers of inscribed circles that are in contact with both the pressure side blade surface and the negative-pressure side blade surface; and
when a distance from a median point of the camber line of each guide vane up to a central point of the maximum inscribed circle is represented as I and a distance from the median point of the camber line up to an end point on an outlet side of the camber line is represented as L, a relationship 0≦I≦0.6 L is satisfied.

### BRIEF DESCRIPTION OF THE DRAWINGS

FIG. 1 is a schematic view showing one structural example of a hydraulic machinery according to one embodiment.

FIG. 2 is a schematically enlarged view showing a stay vane and a guide vane in enlargement, in a section perpendicular to a rotation shaft of the guide vane shown in FIG. 1.

FIG. 3 is a view corresponding to FIG. 2, for explaining a geometric relationship between the stay vane and the guide vane.

FIG. 4 is a schematically enlarged view showing a stay vane and a guide vane in enlargement as a comparative example, with the rotation shaft of the guide vane being omitted.

FIG. 5(a) is a view corresponding to FIG. 2, showing the stay vane and the guide vane in enlargement, with the rotation shaft of the guide vane being omitted.

FIG. 5(b) is a graph showing a flow velocity of flowing water at a predetermined position on a centerline of a flow path, under condition that the guide vane takes a maximum opening degree.

FIG. 6 is a graph showing a relationship between a guide vane opening degree and a pressure loss in the flow path formed between the stay vanes and the guide vanes.

FIG. 7 is a graph showing the guide vane opening degree and a turbine efficiency.

FIG. 8(a) is a view corresponding to FIG. 2, showing the guide vane in enlargement, with the rotation shaft of the guide vane being omitted.

FIG. 8(b) is a graph showing a relationship between a position of the maximum inscribed circle of the guide vane and a head loss in the vicinity of an end point on an outlet side of the guide vane, under condition that the guide vane takes the maximum opening degree.

FIG. 9(a) is a view corresponding to FIG. 2, schematically showing an example in which the positional relationship between the stay vane and the guide vane is modified.

FIG. 9(b) is a view corresponding to FIG. 2, schematically showing another example in which the positional relationship between the stay vane and the guide vane is modified, with the rotation shaft of the guide vane being omitted.

FIG. 10 is a schematic view showing one structural example of a hydraulic machinery.

FIG. 11 is a schematic sectional view showing stay vanes and guide vanes, in a section perpendicular to a rotation shaft of the guide vane shown in FIG. 10.

### MODE FOR CARRYING OUT THE INVENTION

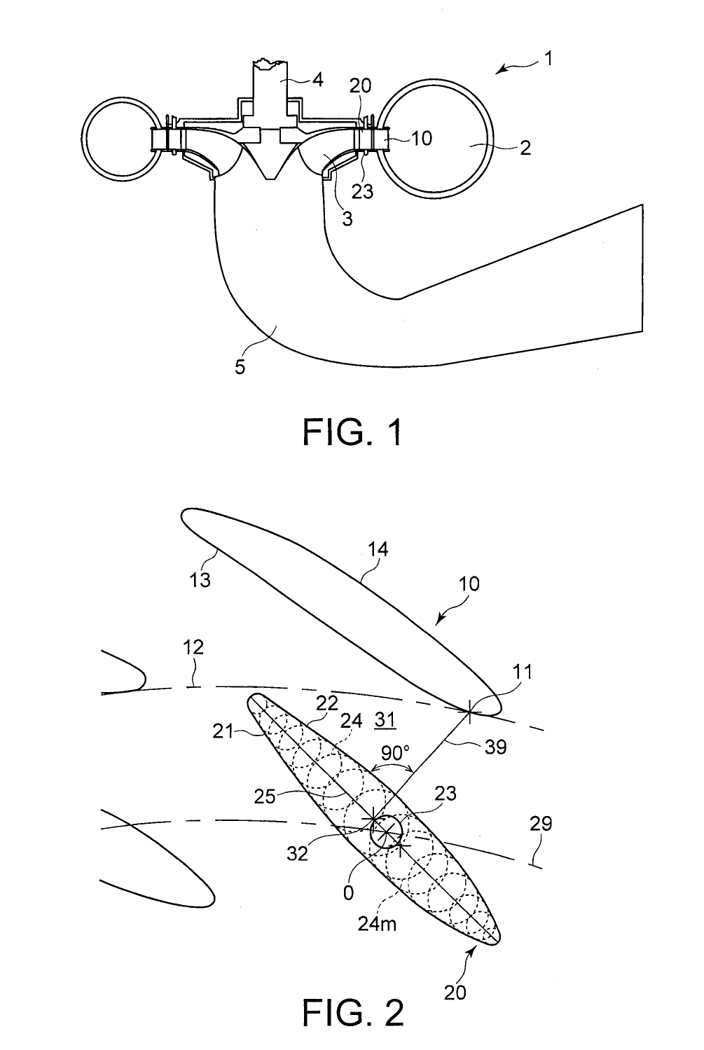

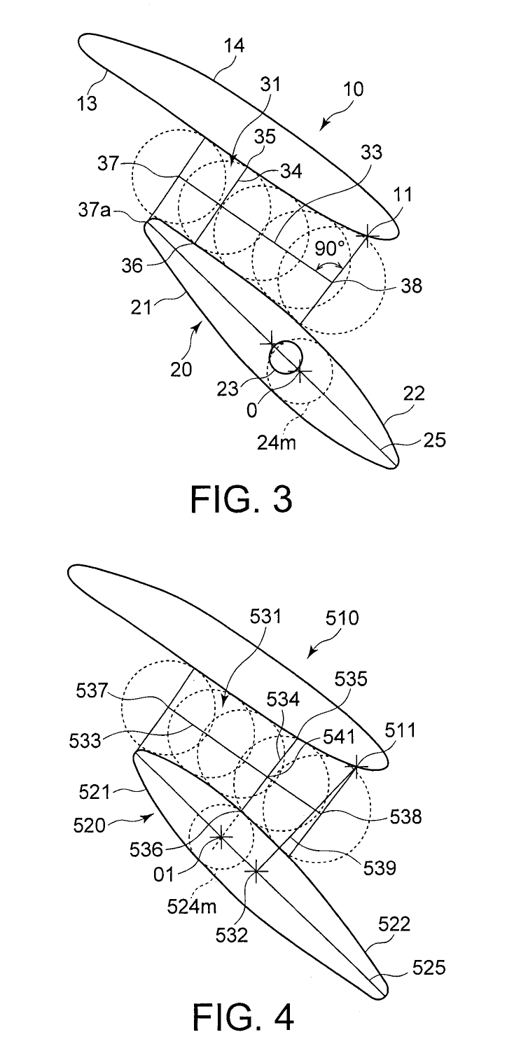

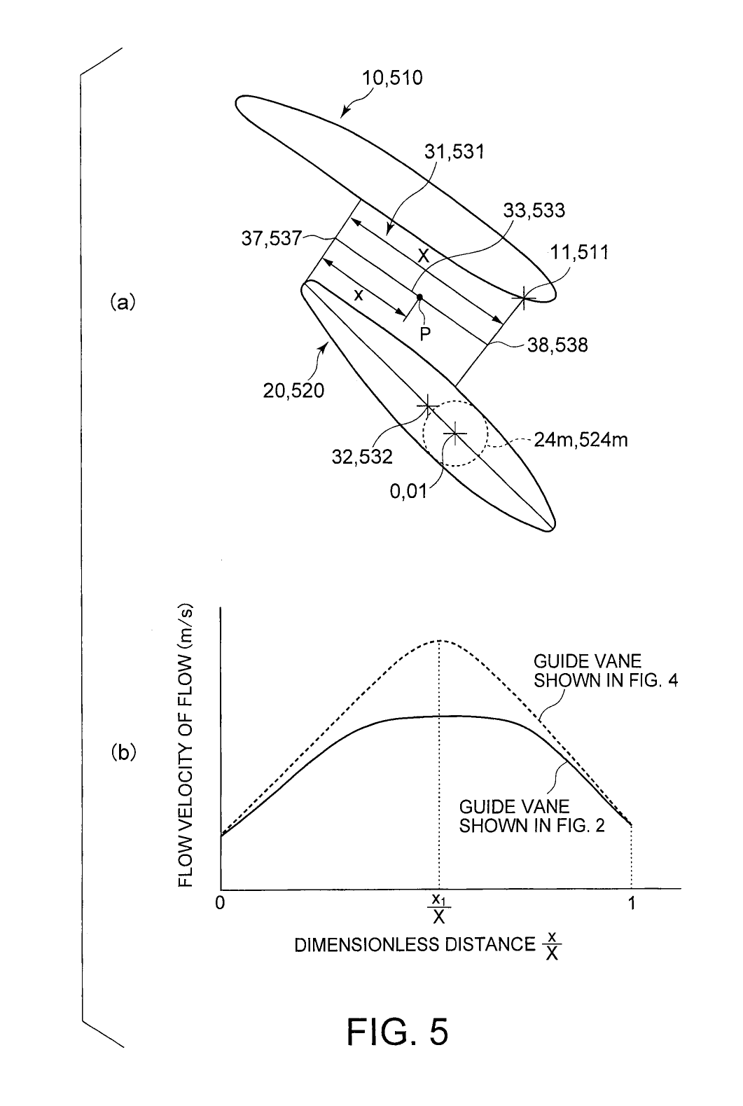

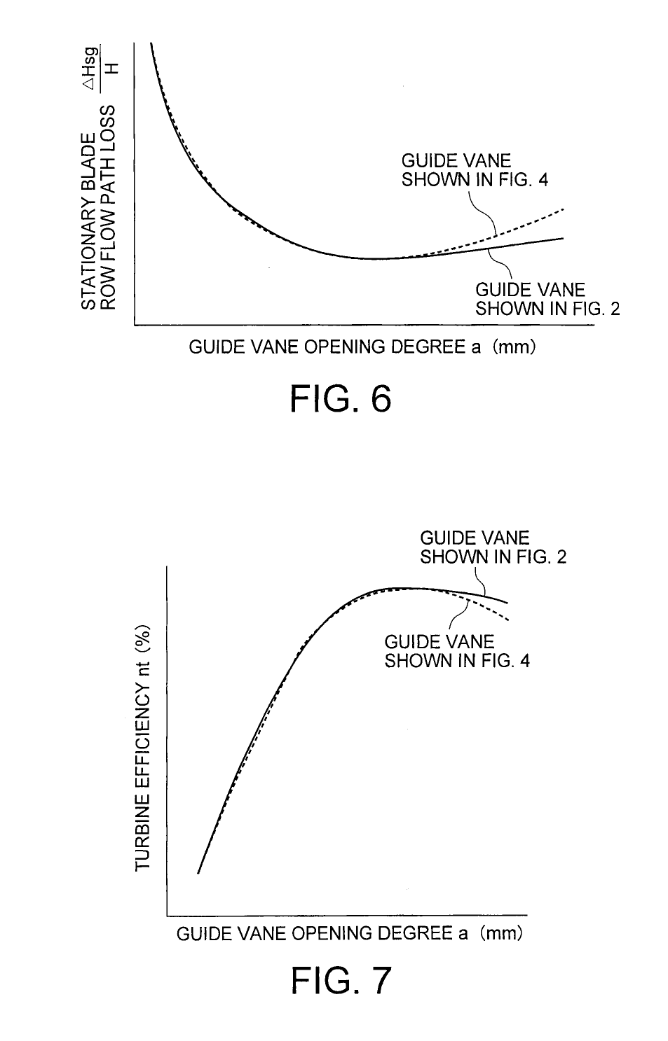

One embodiment will be described herebelow with reference to the drawings. FIG. 1 is a schematic view showing one structural example of a hydraulic machinery according to the embodiment, and FIG. 2 is a schematically enlarged view showing a stay vane and a guide vane in enlargement, in a section perpendicular to a rotation shaft of the guide vane shown in FIG. 1.

A hydraulic machinery 1 according to the embodiment is constructed as a Francis turbine, for example. As shown in FIG. 1, the hydraulic machinery 1 includes a casing 2, a plurality of stay vanes 10 that are circumferentially arranged side by side in the casing 2, and a plurality of guide vanes 20 each of which is arranged inside corresponding stay vane 10 and is configured to be rotated about a rotation shaft 23. A stationary blade row flow path 31 (hereinafter described as “flow path 31”) is formed between the stay vanes 10 and the guide vanes 20. A runner 3 is rotated by flowing water guided through the flow path 31. A turbine main shaft 4 is connected to the runner 3. A generator (not shown) is driven through the turbine main shaft 4.

Next, the respective constituent elements constituting the hydraulic machinery 1 are described. Firstly, the stay vane 10 is described. As shown in FIG. 2, the plurality of stay vanes 10 are circumferentially arranged side by side in the casing 2, as described above. Each of the stay vanes 10 is fixed on the casing 2. In addition, each stay vane 10 has a pressure side blade surface 13 located on the side of the guide vane 20, and a negative-pressure side blade surface 14 located on an opposed side of the pressure side blade surface 13. An outlet end point 11, which is in contact with a common reference circle 12, is laid on an outlet portion of each stay vane 10. In this specification, the outlet end point 11 refers to a point at which the pressure side blade surface 13 of the stay vane 10 firstly contacts the common reference circle 12 on the side of the flow path 31. The stay vanes 10 are provided for rectifying and guiding flowing water to the runner 3.

Next, the guide vane 20 is described. As shown in FIG. 2, the plurality of guide vanes 20 are circumferentially arranged side by side inside the respective stay vanes 10 in the casing 2. Each guide vane 20 is disposed so as to be rotatable about a rotation shaft 23. The rotation shaft 23 of each guide vane 20 is located on a common pitch circle 29. The pitch circle 29 on which the rotation shafts 23 of the respective guide vanes 20 are located is disposed concentrically with the reference circle 12. A diameter of the pitch circle 29 is smaller than that of the reference circle 12. Each guide vane 20 has a pressure side blade surface 21 located on a side of the runner 3 and a negative-pressure side blade surface 22 located on a side of the stay vane 10. In this embodiment, the one guide vane 20 is located inside the one stay vane 10 to correspond thereto. The respective guide vanes 20 are provided for regulating a flowrate of water flowing into the runner 3.

According to such a structure of the hydraulic machinery 1, water flowing from the casing 2 flows through the stationary blade row flow path 31 formed between the stay vanes 10 and the guide vanes 20 on an inner circumferential side to flow into the runner 3. The flowing water rotates the runner 3. Due to the rotation of the runner 3, the generator (not shown) is driven in rotation through the turbine main shaft 4. The water flowing out from the runner 3 is guided to a discharge channel (not shown) via a draft tube 5.

The guide vane 20 is described in more detail. Each of the guide vanes 20 is rotated about the rotation shaft 23 to regulate a guide vane opening degree, so that a flowrate of water flowing between this guide vane 20 and the other guide vane 20 adjacent thereto is varied. Thus, a flowrate of water flowing into the runner 3, which is disposed on an outlet side of the guide vane 20, is regulated, whereby an output of the generator is regulated. For example, by enlarging the guide vane opening degree to increase a flowrate of water flowing into the runner 3, the output of the generator can be increased. The largest guide vane opening degree is called “maximum opening degree” which means a rating maximum opening degree at which a flowrate of water flowing through a flow path formed between the guide vanes 20 adjacent to each other becomes maximum. That is to say, the maximum opening degree of the guide vane 20 means an opening degree of guide vane 20 at which a flow rate of water flowing through a flow path formed between this guide vane 20 and the other guide vane 20 adjacent thereto becomes maximum, among guide vane opening degrees for operating a turbine. The maximum opening degree is predetermined in design for each intended hydraulic machinery 1.

Next, a geometric relationship between the stay vane 10 and the guide vane 20 is described. As described above, an outer contour of each guide vane 20 is defined by the pressure side blade surface 21 and the negative-pressure side blade surface 22. There are inscribed circles 24 which are in contact with both the pressure side blade surface 21 and the negative-pressure side blade surface 22 are. Among these inscribed circles 24, the inscribed circle 24 having the largest diameter is referred to as “maximum inscribed circle 24m”. In addition, a line connecting centers of the inscribed circles 24, which are in contact with both the pressure side blade surface 21 and the negative-pressure side blade surface 22, is referred to as “camber line 25”.

As shown in FIG. 2, under condition that each guide vane 20 takes the maximum opening degree, a line 39 as the shortest distance is drawn from the outlet end point 11 of the stay vane 10 to the negative-pressure side blade surface 22 of the corresponding guide vane 20. An intersection point of the line 39 and the camber line 25 is represented as 32. In this embodiment, a central point O of the maximum inscribed circle 24m, which has the largest diameter among the inscribed circles 24 of the guide vane 20, is located on an outlet side of the guide vane 20, relative to the intersection point 32 of the line 39 and the camber line 25. According to this embodiment, when each guide vane 20 takes the maximum opening degree, the flow path 31 formed between the stay vanes 10 and the guide vanes 20 will not be extremely narrowed by the maximum inscribed circle 24m. Thus, it can be prevented that a flowrate of water flowing through the flow path 31 is locally increased by the maximum inscribed circle 24, whereby a frictional loss between the flowing water and the stay vanes 10 and the guide vanes 20 can be reduced, as well as a water power loss caused by a flow separation or eddy in the stationary blade row flow path 31 can be effectively restrained.

FIG. 3 is a view corresponding to FIG. 2, which is a schematically enlarged view for further explaining the geometric relationship between the stay vane 10 and the guide vane 20.

As shown in FIG. 3, in a section perpendicular to an axial direction of the rotation shaft 23, a given line 34, which intersects with a centerline 33 of the flow path 31 formed between the stay vane 10 and the guide vane 20, is drawn. Intersection points at which the line 34 intersects with the stay vane 10 and the guide vane 20 are respectively represented as 35 and 36. In this case, it is preferable that a distance between the two intersection points 35 and 36 continuously increases from a most upstream end 37 of the centerline 33 of the flow path 31 toward a most downstream end 38 thereof.

Herein, the most upstream end 37 of the centerline 33 of the flow path 31 is defined as follows (see FIG. 3). At first, in the section perpendicular to the axial direction of the rotation shaft 23, a line running through a most upstream end point 37a of the guide vane 20 is selected among the given lines 34 perpendicular to the centerline 33 of the flow path 31. The most upstream end 37 means an intersection point 37 at which the selected line intersects with the centerline 33 of the flow path 31. On the other hand, the most downstream end 38 of the centerline 33 of the flow path 31 is defined as follows (see FIG. 3). At first, in the section perpendicular to the axial direction of the rotation shaft 23, a line running through the outlet end point 11 of the stay vane 10 is selected among the given lines 34 perpendicular to the centerline 33 of the flow path 31. The most downstream end 38 means an intersection point 38 at which the selected line 34 intersects with the centerline 33 of the flow path 31. According to this embodiment, under condition that each guide vane 20 takes the maximum opening degree, a flowrate of water flowing through the flow path 31 formed between the stay vanes 10 and the guide vanes 20 continuously increases from the most upstream end 37 of the centerline 33 of the flow path 31 toward the most downstream end 38 thereof. In accordance therewith, a flow velocity of the water flowing through the flow path 31 continuously decreases from the most upstream end 37 of the centerline 33 of the flow path 31 toward the most downstream end 38 thereof. Thus, there is no possibility that a flow velocity locally increases or decreases. As a result, a water power loss caused by a flow separation or eddy in the stationary blade row flow path 31 can be more effectively restrained.

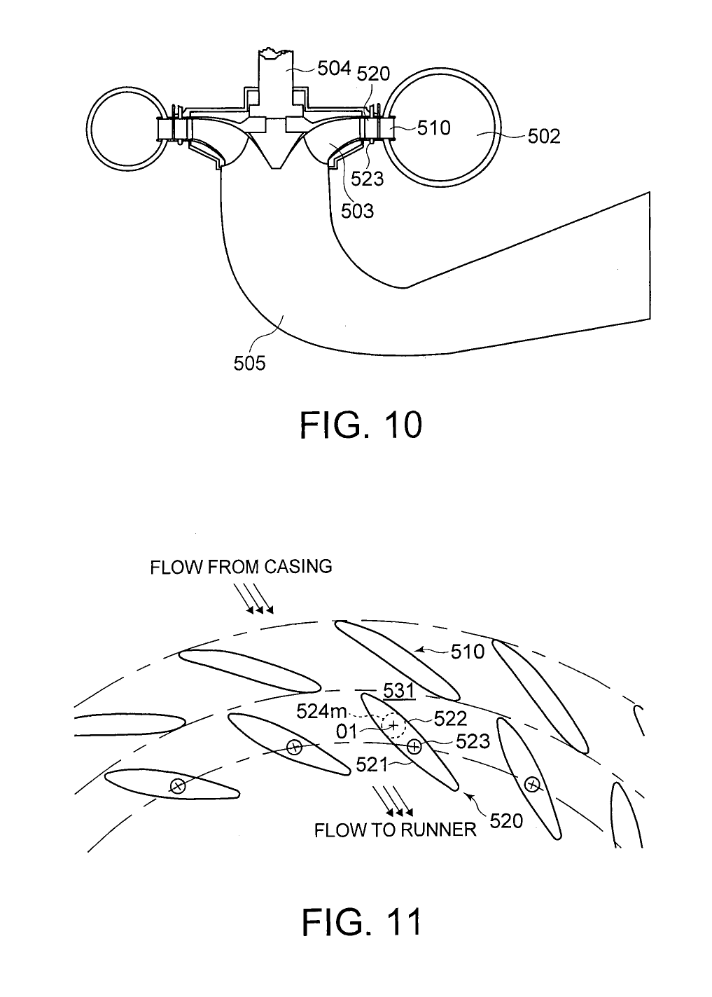

As a comparative example, FIG. 4 shows a stay vane 510 and a guide vane 520 in enlargement in a hydraulic machinery. In FIG. 4, the stay vane 510 and the guide vane 520 correspond to the stay vane 510 and the guide vane 520 of the hydraulic machinery shown in FIG. 10. In addition, in FIG. 4, illustration of the rotation shaft 523 of the guide vane 420 is omitted. As shown in FIG. 4, a position of the maximum inscribed circle 524m of the guide vane 520 is different from the position of the maximum inscribed circle 24m of the guide vane 20 shown in FIG. 3. Other structure of the guide vane 520 and the structure of the stay vane 510, which are shown in FIG. 4, are substantially the same as the structure of the guide vane 20 and the structure of the stay vane 10, which are shown in FIG. 3. As shown in FIG. 4, under condition that each guide vane 520 takes the maximum opening degree, a line 539 as the shortest distance is drawn from an outlet end point 511 of the stay vane 510 to a negative-pressure side blade surface 522 of the corresponding guide vane 520. An intersection point of the line 539 and a camber line 525 is represented as 532. At this time, differently from the case of the guide vane 20 shown in FIG. 2, a central point O1 of a maximum inscribed circle 524m, which has the largest diameter among inscribed circles 524 of the guide vane 520, is located on an inlet side of the guide vane 520, relative to the intersection point 523 of the line 539 and a camber line 525. In addition, as shown in FIG. 4, in a section perpendicular to an axial direction of the rotation shaft 523, a given line 534 perpendicular to a centerline 533 of the flow path 531 is drawn. Intersection points at which the line 534 intersects with the stay vane 510 and the guide vane 520 are respectively represented as 535 and 536. In this case, differently from the case of the guide vane 20 shown in FIG. 2, a distance between the two intersection points 535 and 536 shown in FIG. 4 does not continuously increase from a most upstream end 537 of the centerline 533 of the flow path 531 toward a most downstream end 538 thereof. Specifically, a line running through the central point O1 of the maximum inscribed circle 524m of the guide vane 20 is selected among the given lines 534 that are perpendicular to the centerline 533 of the flow path 531. An intersection point at which the selected line interests with the centerline 533 is represented as 541. In this case, the distance between the two intersection points 535 and 536 gradually decreases from the most upstream end 537 of the centerline 533 toward the intersection 541 and then gradually increases from the intersection 541. toward the most downstream end 538.

Next, there is explained a difference in flow velocity between when the guide vane 20 shown in FIG. 2 is applied and when the guide vane 520 shown in FIG. 4 is applied, with reference to FIGS. 5(a) and 5(b). FIG. 5(a) is a view corresponding to FIG. 2, showing the stay vane 10 and the guide vane 20 in enlargement, and FIG. 5(b) is a graph showing a flow velocity of flow (flowing water) at a predetermined position on the centerline 33 of the flow path 31, under condition that the guide vane 20 takes a maximum opening degree. As shown in FIG. 5(a), a distance from the most upstream end 37, 537 of the centerline 33, 533 of the flow path 31, 531 up to the most downstream end 38, 538 thereof is represented as X. A distance from the most upstream end 37, 537 of the centerline 33, 533 of the flow path 31, 531 up to a predetermined point P is represented as x. The axis of abscissa of the graph shown in FIG. 5(b) shows a dimensionless distance x/X and the axis of ordinate of the graph shows a flow velocity (m/s) of the flow at the point P when the guide vane 20 takes the maximum opening degree. In FIG. 5(b), x₁ represents a value of x when the line 534 that runs through a predetermined point P on the centerline 33, 533 perpendicularly to the centerline 533 runs through the central point O1 of the maximum inscribed circle 524m of the guide vane 520 shown in FIG. 4. As can be understood from the graph shown in FIG. 5(b), as compared with the case where the guide vane 520 shown in FIG. 4 is applied, the increase in flow velocity of the flow can be more restrained in the case where the guide vane 20 shown in FIG. 2 is applied. Thus, the frictional loss in the flow path that will increase correspondingly to the flow velocity can be similarly restrained. In particular, in the vicinity of the position at which x=x₁, the difference in flow velocity becomes significant between the guide vane 20 shown in FIG. 2 and the guide vane 520 shown in FIG. 4. This is because, when the guide vane 520 shown in FIG. 4 is applied, as described above, since the flow path 531 formed between the stay vanes 510 and the guide vanes 520 becomes extremely narrow in the vicinity of the maximum inscribed circle 524m, the flow velocity in the flow path 531 in the vicinity of the maximum inscribed circle 524m locally increases. For this reason, when the guide vane 520 shown in FIG. 4 is applied, a larger frictional loss between the flowing water and the stay vanes 510 and the guide vanes 520 is likely to take place, as well as a larger water power loss caused by a flow separation or eddy in the stationary blade row flow path 531 are likely to take place.

Next, there is described a difference in pressure loss between when the guide vane 20 shown in FIG. 2 is applied and when the guide vane 520 shown in FIG. 4 is applied, with reference to FIGS. 6 and 7. In FIG. 6, the axis of abscissa shows the guide vane opening degree a (mm) and the axis of ordinate shows the pressure loss ΔHsg/H in the flow path 31, 531 formed between the stay vanes 10, 510 and the guide vanes 20, 520. In FIG. 7, the axis of abscissa shows the guide vane opening degree a (mm) and the axis of ordinate shows the turbine efficiency η_{γ}(%). As can be understood from FIG. 6, as compared with the case where the guide vane 520 shown in FIG. 4 is applied, the loss ΔHsg/H in the stationary blade row flow path 31 can be more restrained in the case where the guide vane 20 shown in FIG. 2 is applied, when the guide vane opening degree a is enlarged to output a larger power. Thus, as shown in FIG. 7, as compared with the case where the guide vane 520 shown in FIG. 4 is applied, the turbine efficiency η_{γ} in the vertical interval within the operation range is higher in the case where the guide vane 20 shown in FIG. 2 is applied, when the guide vane opening degree a is enlarged to output a larger power.

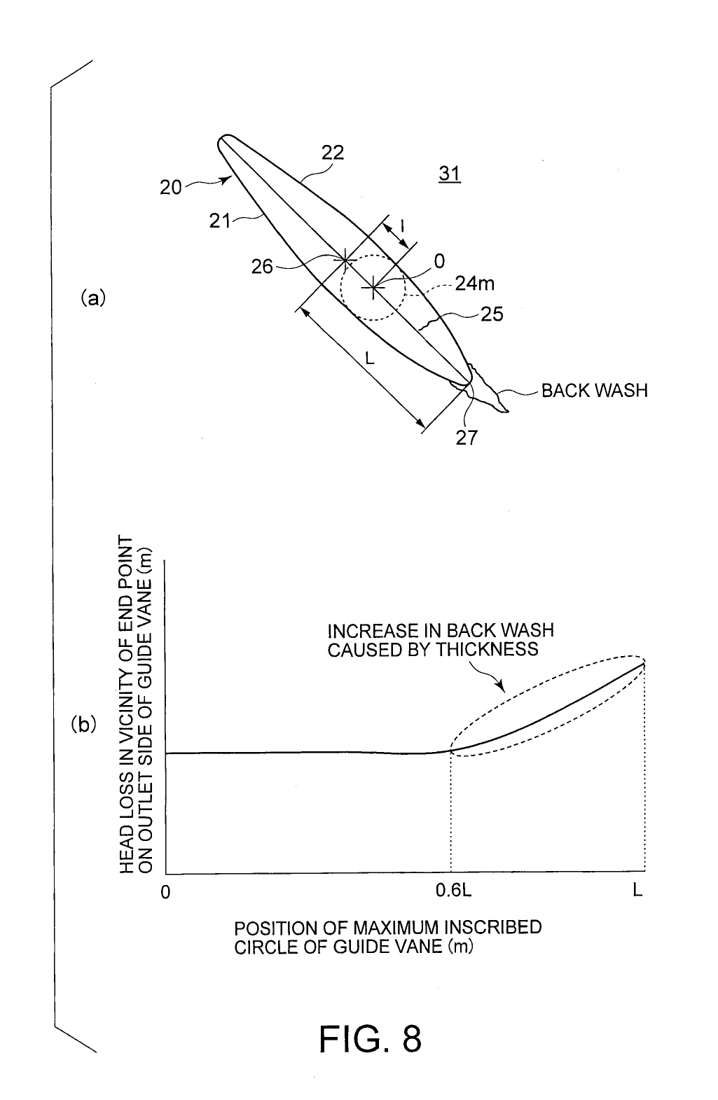

Next, there is explained a position of the maximum inscribed circle 24m of the guide vane 20 in this embodiment, with reference to FIGS. 8(a) and 8(b). FIG. 8(a) is a view corresponding to FIG. 2, showing the guide vane 20 in enlargement and FIG. 8(b) is a graph showing a relationship between a position of the maximum inscribed circle 24m of the guide vane 20 and a head loss in the vicinity of an end point 27 on the outlet side of the guide vane 20, under condition that the guide vane 20 takes the maximum opening degree. As shown in FIG. 8(a), a distance from a median point 26 of the camber line 25 of the guide vane 20 up to the central point O of the maximum inscribed circle 24m is represented as I. A distance from the median point 26 of the camber line 25 up to the end point 27 on the outlet side of the camber line 25 is represented as L. The median point 26 of the camber line 25 means a central point in the full length of the camber line 25. In the graph of FIG. 8(b), the axis of abscissa shows the distance I and the axis of ordinate shows the head loss in the vicinity of the end point 27 on the outlet side of the guide vane 20. As shown in FIG. 8(b), when I>0.6 L, a curvature from a maximum thickness position near the maximum inscribed circle 24m of the guide vane 20 toward the end point 27 on the outlet side become larger. Thus, a large back wash is generated downstream of the end point 27 on the outlet side of the guide vane 20, which increases the head loss on the outlet side of the guide vane 20. That is to say, the guide vane 20 in this embodiment preferably has a structure that satisfies a relationship 0≦I≦0.6 L.

As described above, according to this embodiment, under condition that each guide vane 20 takes the maximum opening degree, the flow path 31 formed between the stay vanes 10 and the guide vanes 20 will not be extremely narrowed by the maximum inscribed circle 24m. Thus, it can be prevented that a flowrate of water flowing through the flow path 31 is locally increased by the maximum inscribed circle 24, whereby a frictional loss between the flowing water and the stay vanes 10 and between the flowing water and the guide vanes 20 can be reduced, as well as a water power loss caused by a flow separation or eddy in the stationary blade row flow path 31 can be effectively restrained.

In the aforementioned embodiment, the positional relationship between the stay vane 10 and the guide vane 20 can be optionally modified, depending on a generator capacity and/or used conditions.

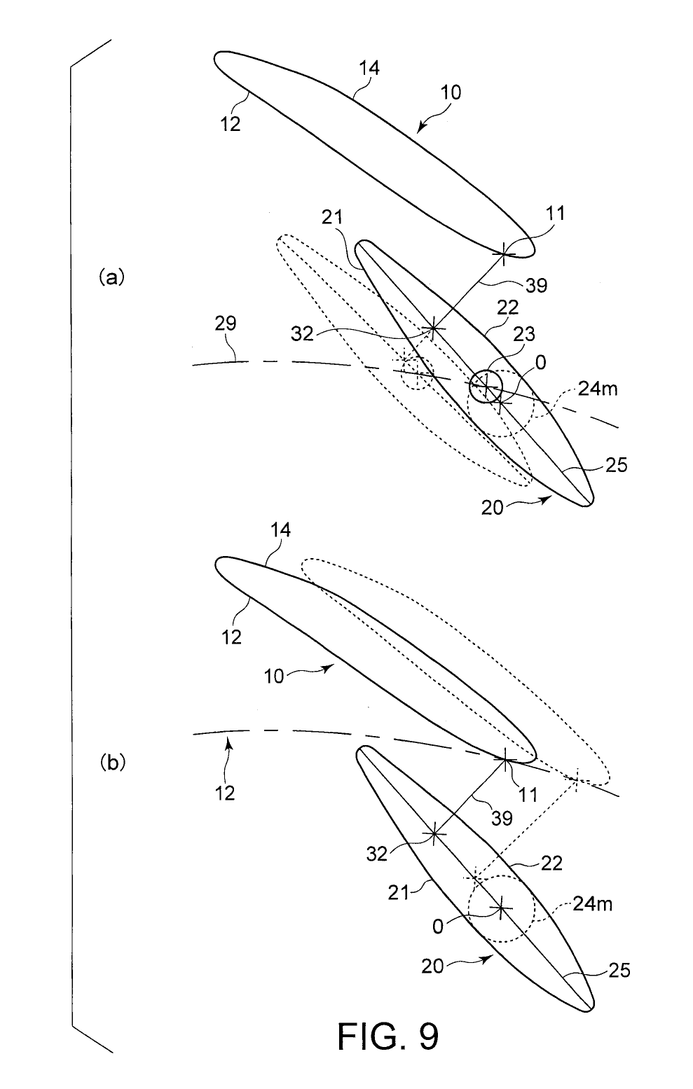

FIGS. 9(a) and 9(b) show modified examples of the relationship between the stay vane 10 and the guide vane 20. In the example shown in FIG. 9(a), the rotation shaft 23 of the guide vane 20 is circumferentially moved (clockwise in the illustrated example) along the pitch circle 29 to come close to the stay vane 10. In the example shown in FIG. 9(b), the outlet end point 11 of the stay vane 11 is circumferentially moved (counterclockwise in the illustrated example) along the reference circle 12 to come close to the guide vane 20. As compared with the case shown in FIG. 2, in both the guide vane 20 shown in FIG. 9(a) and the guide vane 20 shown in FIG. 9(b), the intersection point 32 of the line 39 and the camber line 25 is located on the inlet side of the guide vane 20. In addition, as shown in FIGS. 9(a) and 9(b), the central point O of the maximum inscribed circle 24m of the guide vane 20 is located nearer the outlet side of the guide vane 20 to the intersection point 32. Also according to the modification examples shown in FIGS. 9(a) and 9(b), since the central point O of the maximum inscribed circle 24m, which has the largest diameter among the inscribed circles 24 of the guide vane 20, is located on the outlet side of the guide vane 20, relative to the intersection point 32 of the line 39 and the camber line 25, the same operational effect as that of the above embodiment can be obtained.

In the aforementioned embodiment, as shown in FIG. 3, in the section perpendicular to the axial direction of the rotation shaft 23, when the intersection points at which the give line 34 perpendicular to the centerline 33 of the flow path 31 intersects with the stay vane 10 and the guide vane 20 are represented as 35 and 36, the distance between the intersection points 35 and 36 continuously increases from the most upstream end 37 of the centerline 33 of the flow path 31 toward the most downstream end 38, which is shown by way of example. However, the present invention is not limited to such an example. As another example, in the section perpendicular to the axial direction of the rotation shaft 23, when the intersection points at which the give line 34 perpendicular to the centerline 33 of the flow path 31 intersects with the stay vane 10 and the guide vane 20 are represented as 35 and 36, the distance between the intersection points 35 and 36 continuously may decrease from the most upstream end 37 of the centerline 33 of the flow path 31 toward the most downstream end 38. According to this embodiment, when each guide vane 20 takes the maximum opening degree, it is possible to restrain increase in a frictional loss and a water power loss caused by a flow separation or eddy, without any local increase in flow velocity.

The embodiment is taken as an example, and the scope of the present invention is not limited thereto.

1 Hydraulic machinery

2 Casing

3 Runner

4 Turbine main shaft

5 Draft tube

10 Stay vane

11 Outlet end point

12 Reference Circle

13 Pressure side blade surface

14 Negative-pressure side blade surface

20 Guide vane

21 Pressure side blade surface

22 Negative-pressure side blade surface

23 Rotation shaft

24 Inscribed circle

24m Maximum inscribed circle

25 Camber line

26 Median point

27 End point

19 Pitch circle

31 Flow path

32 Intersection point

33 Centerline

34 Line

35 Intersection point

36 Intersection point

37 Most upstream end

38 Most downstream end

502 Casing

503 Runner

504 Turbine shaft

505 Draft tube

506 Reference circle

510 Stay vane

511 Outlet end point

520 Guide vane

521 Pressure side blade surface

522 Negative-pressure side blade surface

523 Rotation shaft

524 Inscribed circle

524m Maximum inscribed circle

525 Camber line

531 Flow path

532 Intersection point

533 Centerline

541 Intersection point

1. A hydraulic machinery comprising:
a plurality of stay vanes that are circumferentially arranged side by side, each including an outlet end point; and
a plurality of guide vanes that are arranged inside the corresponding stay vanes, each including a pressure side blade surface and a negative-pressure side blade surface, and being configured to be rotated about a rotation shaft;
wherein:
the outlet end point of each stay vane is in contact with a common reference circle;
each guide vane has a camber line connecting centers of inscribed circles that are in contact with both the pressure side blade surface and the negative-pressure side blade surface; and
when each guide vane takes a maximum opening degree, a central point of a maximum inscribed circle, which has the largest diameter among the inscribed circles of the guide vane, is located on an outlet side of the guide vane, relative to an intersection point at which a line as the shortest distance, which is drawn between the outlet end point of the stay vane and the negative-pressure side blade surface of the corresponding guide vane, and the camber line intersect with each other.

2. The hydraulic machinery according to claim 1, wherein:
a flow path is formed between the guide vanes and the stay vanes; and
when the flow path is seen from a section perpendicular to an axial direction of the rotation shaft, a distance between two intersection points, which are defined as intersection points at which a given line perpendicular to a centerline of the flow path intersects with the respective guide vane and the stay vane, continuously increases from a most upstream end of the centerline of the flow path toward a most downstream end thereof.

3. The hydraulic machinery according to claim 1, wherein:
a flow path is formed between the guide vanes and the stay vanes; and
when the flow path is seen from a section perpendicular to an axial direction of the rotation shaft, a distance between two intersection points, which are defined as intersection points at which a given line perpendicular to a centerline of the flow path intersects with the respective guide vane and the stay vane, continuously decreases from a most upstream end of the centerline of the flow path toward a most downstream end thereof.

4. The hydraulic machinery according to claims 1, wherein:
when a distance from a median point of the camber line of each guide vane up to a central point of the maximum inscribed circle is represented as I and a distance from the median point of the camber line up to an end point on an outlet side of the camber line is represented as L, a relationship 0≦I≦0.6 L is satisfied.

5. A hydraulic machinery comprising:
a plurality of stay vanes that are circumferentially arranged side by side; and
a plurality of guide vanes that are arranged inside the corresponding stay vanes, each including a pressure side blade surface and a negative-pressure side blade surface, and being configured to be rotated about a rotation shaft;
wherein:
each guide vane has a camber line connecting centers of inscribed circles that are in contact with both the pressure side blade surface and the negative-pressure side blade surface; and
when a distance from a median point of the camber line of each guide vane up to a central point of the maximum inscribed circle is represented as I and a distance from the median point of the camber line up to an end point on an outlet side of the camber line is represented as L, a relationship 0≦I≦0.6 L is satisfied.
